(19) United States
(12) Patent Application Publication
(10) Pub. No.: US 2007/0144677 A1
(43) Pub. Date: Jun. 28, 2007

(54) Splicing tape

(76) Inventor: Timothy W. Rawlings, Waynesville, OH (US)

Correspondence Address: Adam Bennett;Intellectual Property Section, Law Department, NCR Corporation, 1700 South Pattercon Blvd., Dayton, OH, 45479-0001, US

(21) Appl. No.: 11/318,848

(22) Filed: Dec. 27, 2005

(51) Int. Cl. B65H 19/00; B32B 7/12; G06F 17/00

(52) U.S. Cl. 156/502; 156/157; 428/343; 235/375

(57) ABSTRACT

A length of splicing tape is provided for splicing a trailing end of a first material to a leading end of a second material. The splicing tape includes an identification device. The identification device is used to allow detection of a splice defined by the splicing of the trailing end of the first material and the leading end of the second material.

### FIELD OF THE INVENTION

The present invention relates generally to splicing tape, splicing systems, and systems for processing elongate materials. The invention has been primarily developed for enabling automatic detection of a splice in an elongate material, and will be described herein by particular reference to that application. However, the invention is by no means restricted as such, and has various alternate applications.

### BACKGROUND

Splicing is a process commonly used when dealing with elongate materials, such as raw spooled paper or materials for web-format processing. Splicing assists the production of long continuous spools of the elongate material. More specifically, a trailing end of a first material is spliced to a leading end of a second material such that the first and second materials define a continuous length.

Splicing is typically carried out using an adhesive splicing tape. The tape is applied laterally across the trailing and leading ends such that a continuous length of material is in effect defined.

When processing a material that is suspected to include one or more splices, it is often necessary to monitor the processing to identify any splices. The splice itself—and often a surrounding region—is typically regarded as waste and is not fit for processing or end-user consumption.

In a specific example, a spool of material suspected to include one or more splices is continuously passed through a processing machine. A person physically observes the passage of the material into the machine, and stops the machine in response to observing a splice. Splicing tape is often brightly colored to assist the person in this task. Having stopped the machine, the splice and the surrounding region of waste material are manually extracted, and subsequently the machine is initiated to re-commence processing.

It is not uncommon for such processing machines to process thousands of feet of material per minute. As such, the time taken to manually remove a spliced region results in considerable adverse effects to throughput and productivity.

### SUMMARY

It is an object of the present invention to overcome or ameliorate at least one of the disadvantages of the prior art, or to provide a useful alternative.

In accordance with a first aspect of the invention, there is provided splicing tape for splicing a trailing end of a first material to a leading end of a second material, the splicing tape including an identification device responsive to an interrogation signal for providing an information packet.

In some embodiments, the identification device is an RFID tag.

The tape may include a plurality of longitudinally spaced identification devices. In some embodiments, the identification devices are equally longitudinally spaced by a predefined spacing dimension. In some embodiments, the first material has a substantially constant lateral dimension, and the spacing dimension is predefined by reference to the lateral dimension. Typically the spacing dimension is between approximately 80% and 100% of the lateral dimension.

In some embodiments, the tape includes a plurality of longitudinally spaced markers for designating tape portions, each tape portion including an equal predetermined number of identification devices. The number one is often selected as the equal predetermined number.

In some embodiments each of the identification devices is indicative of a unique identifier.

According to a second aspect of the invention, there is provided a system for processing an elongate material having an identification device indicative of a splice, the system including: a station for providing a processing path having an input for receiving the material and an output for dispensing the material; a reader for providing an interrogation signal intermediate the input and the output to obtain from the identification device an information packet; and a processor responsive to the information packet for selectively providing a signal.

In some embodiments, the signal is indicative of positional information relating to the splice. In some cases the positional information is indicative of a destination of the splice. In some embodiments the output dispenses the material to a batch, and the positional information is provided to indicate the expected presence of the splice in the batch. The positional information may be indicative of the passage of the splice in station.

In some embodiments the station includes a splice extraction assembly responsive to the positional information for extracting a portion of the material including the splice.

In some embodiments, the identification device is a RFID tag.

According to a third aspect of the invention, there is provided a method for identifying a splice in an elongate material, the method including the step of mounting an identification device to the material such that the identification device is responsive to an interrogation signal for providing an information packet indicative of the splice.

According to a further aspect of the invention, there is provided a splicing system including: a splicing station for splicing a trailing end of a first material to a leading end of a second material; and a tagging station for mounting an identification device in a position fixed with respect to either or both of the first and second ends.

In some embodiments, the identification device is responsive to an interrogation signal for providing an information packet.

### BRIEF DESCRIPTION OF THE DRAWINGS

Benefits and advantages of the present invention will become apparent to those skilled in the art to which this invention relates from the subsequent description of exemplary embodiments and the appended claims, taken in conjunction with the accompanying drawings, in which:

FIG. 1 is a perspective view of a portion of splicing tape according to an embodiment of the invention, shown splicing a first material to a second material;

FIG. 2 is a schematic representation of a processing system according to an embodiment of the invention;

FIG. 3 is a schematic view of a processing system according to another embodiment;

FIG. 4 is a schematic view of a processing system according to another embodiment;

FIG. 5 is a schematic view of a processing system according to another embodiment;

FIG. 6 is a schematic view of a processing system according to another embodiment;

FIG. 7 is a perspective view of splice having an adjacent identification device;

FIG. 8 is a representation similar to that of FIG. 1.

FIG. 9 is a perspective view of a roll of the splicing tape of FIG. 1; and

FIG. 10 is a schematic representation of a splicing system.

### DETAILED DESCRIPTION

Referring to the drawings, it will be appreciated that, in the different figures, corresponding features have been denoted by corresponding reference numerals.

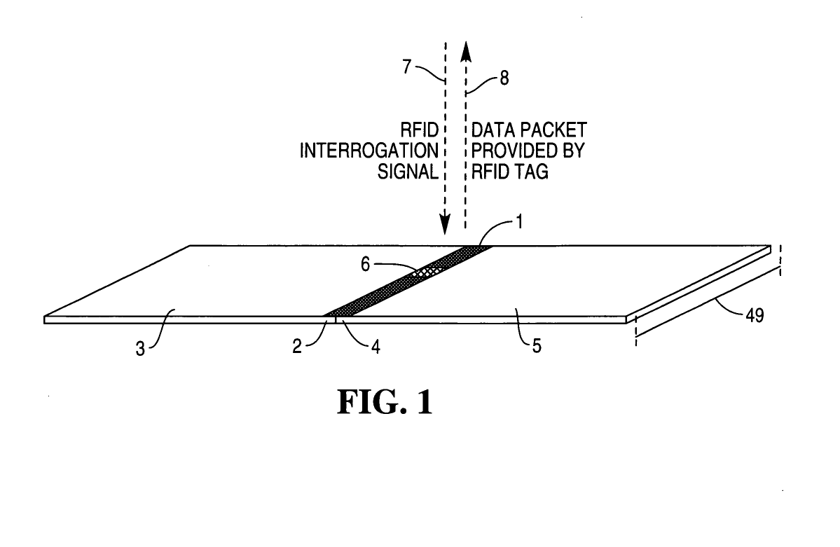

FIG. 1 illustrates a length of splicing tape 1 for splicing a trailing end 2 of a first material 3 to a leading end 4 of a second material 5. Tape 1 includes an identification device, in the form of an RFID tag 6. Tag 6 is responsive to an RF interrogation signal 7 for providing an information packet 8. In a preferred embodiment, tag 1 is used to allow convenient electronic detection of a splice 9 defined by the splicing of ends 2 and 4.

Although FIG. 1 shows tag 6 as surface mounted, this should not be taken as limiting. For example, in other embodiments tag 6 is embedded.

Although embodiments presently disclosed are particularly concerned with RFID technology, this should not be regarded as limiting to the scope of the invention. In alternate embodiments other identification devices are used, such as barcodes.

Tag 6 is remotely electronically detectable using an appropriate RF signal, such as signal 7. This, in turn, facilitates remote electronic identification of splice 9. Preferably tape 1 is used in conjunction with a processing system that takes advantage of this functionality to assist in the processing of materials suspected to include one or more splices 9.

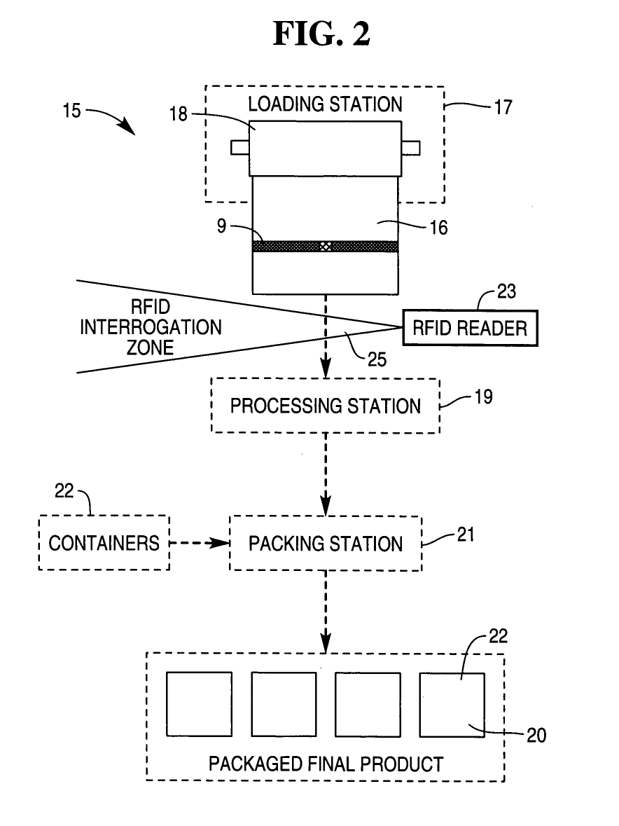

FIG. 2 illustrates an exemplary processing system 15 that makes use of tape 1 during processing of spooled paper 16. System 1 includes a loading station 17 for maintaining a spool 18 of paper 16. Paper 16 is continuously drawn from spool 18 toward a processing station 19. Station 19 receives paper, performs various processing steps (such as printing, perforation, lamination, and so on) and provides processed items 20. These items are provided to a packing station 21 where they are automatically packed into containers 22. The containers are sequentially filled such that each container is filled with a predetermined quantity of items 20. Filled containers 22 are stockpiled for later shipping to purchasing parties, or bulk encasement in larger storage containers.

Exemplary systems such as system 15 are provided only for the sake of description, and should not be regarded as limiting in any sense. Their purpose is to show functionality of the invention in generic practical situations. For example: alternate processing systems are used in conjunction with products manufactured via web format, laminates, film, foil, boxboard, and other roll/fold or sheet products.

Spool 18 is suspected to include one or more splices 9. These splices are formed using tape 1, substantially as shown in FIG. 1. Automated splice identification is possible due to tags 6. In this embodiment, an RFID reader 23 is utilized, this reader providing an interrogation signal in the form of an RFID interrogation zone 25. The entry of a splice 9 into zone 25 results in reading of tag 6, and the provision of information packet 8 to reader 23. As such, reader 23 is informed of the presence of the splice. Reader 25 provides a signal 26 on the basis of packet 8. This signal is used for a variety of purposes between embodiments, typically being directed toward managing the processing of spliced portions of paper 16. Some exemplary embodiments are described below.

In some embodiments signal 26 is indicative of data derived from packet 8, whilst in other embodiments signal 26 is indicative only of the detection of a tag 6. This is typically dependant on the intended functionality of system 15. Signal 26 is used for variety of purposes among embodiments, and some of these are discussed in greater detail further below.

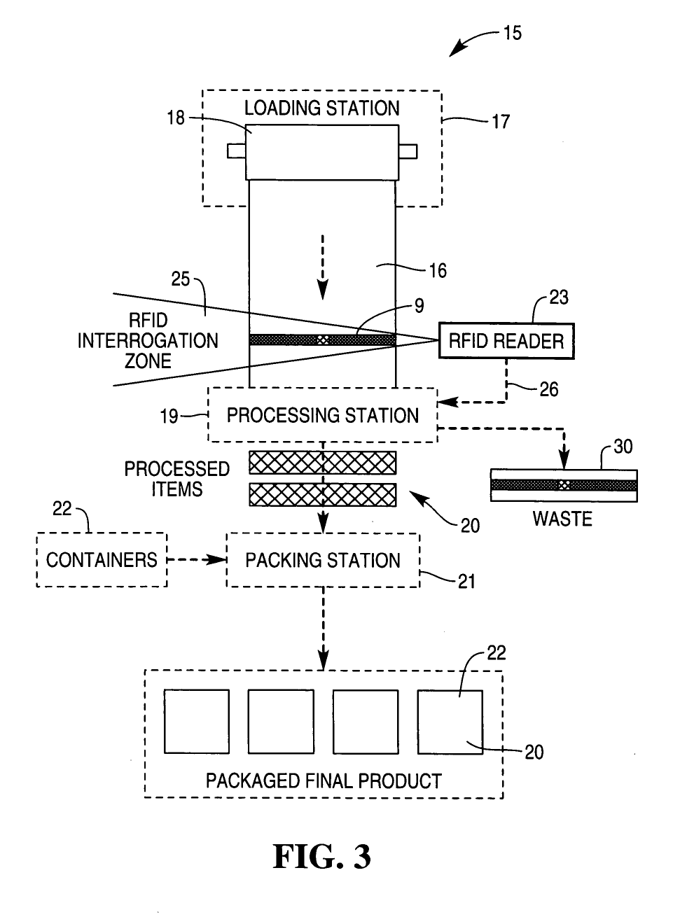

In the embodiment of FIG. 3, zone 25 is provided intermediate stations 18 and 19. Station 19 is responsive to signal 26 for actuating an extractor such that splice 9 is not converted into items 20. This is generally referred to as “detection upstream of processing”. In this embodiment, station 19 is responsive to signal 26 for designating a portion 30 of paper 16 as waste, this portion being defined by a predetermined longitudinal distance on the leading and trailing side of splice 9. Splice-affected waste portion 30 is automatically extracted within station 9, and as such not converted into items 20.

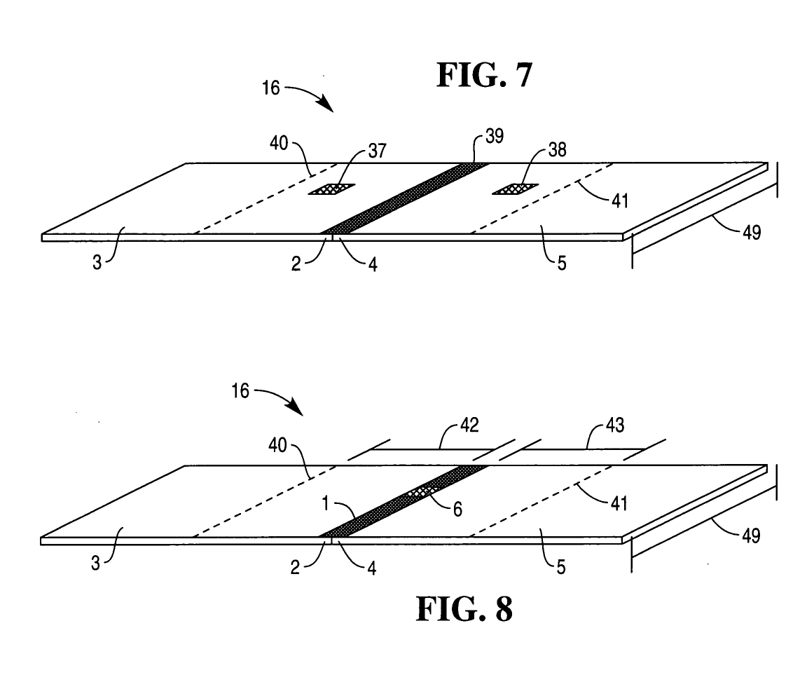

Some techniques for designating portion 30 are discussed further below by reference to FIGS. 7 and 8.

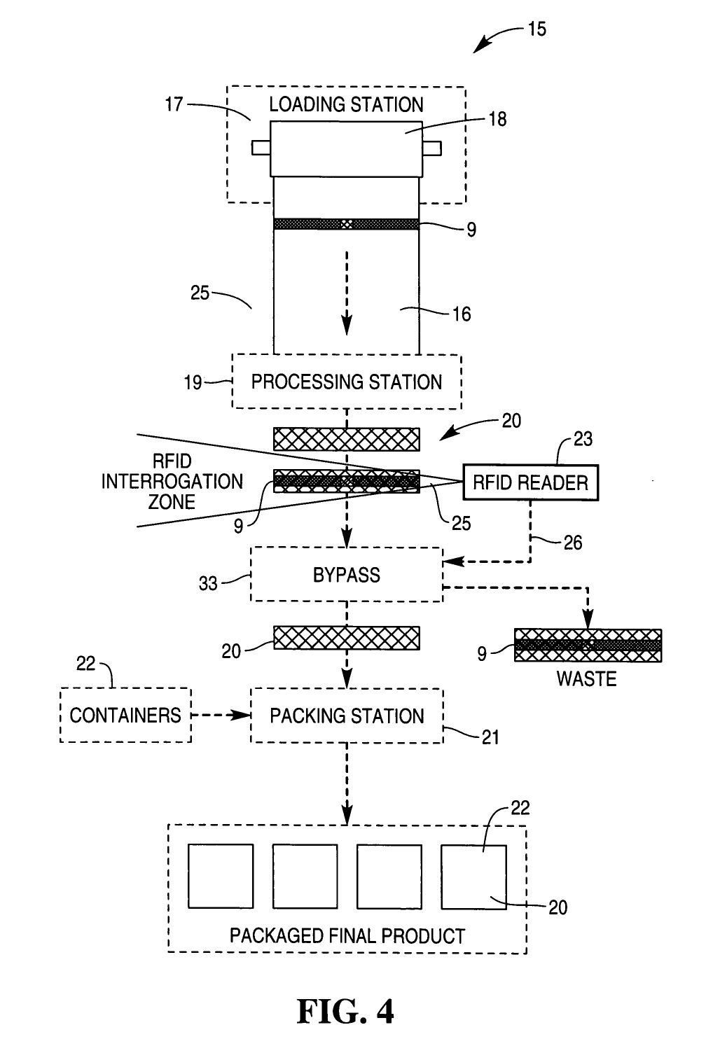

In the embodiment of FIG. 4, zone 25 is provided intermediate stations 19 and 21. In this case, a bypass 33 is responsive to signal 26 such that an item 20 containing a splice 9 is not packaged into a container 22. This is generally referred to as “detection downstream of processing”. In simple terms, the ingress into zone 25 by a portion of tape 1 containing a tag 6 actuates bypass 33. This bypass 33 extracts the item 20 containing that tape 1 such that it does not reach station 21.

It will be recognized that the embodiments of FIGS. 3 and 4 have respective practical advantages and disadvantages in certain situations. For example, the embodiment of FIG. 4 is typically more readily implemented in conjunction with faster processing rates given that physical extraction of splice-affected waste portion 30 is not required. However, in situations where the presence of a splice 9 is known to cause practical complications in station 19, the embodiment of FIG. 3 is typically preferred. For example: where tape 1 causes blockages in processing machinery. Selection between detection upstream and downstream of processing is typically made on the basis of an efficiency and/or convenience determination.

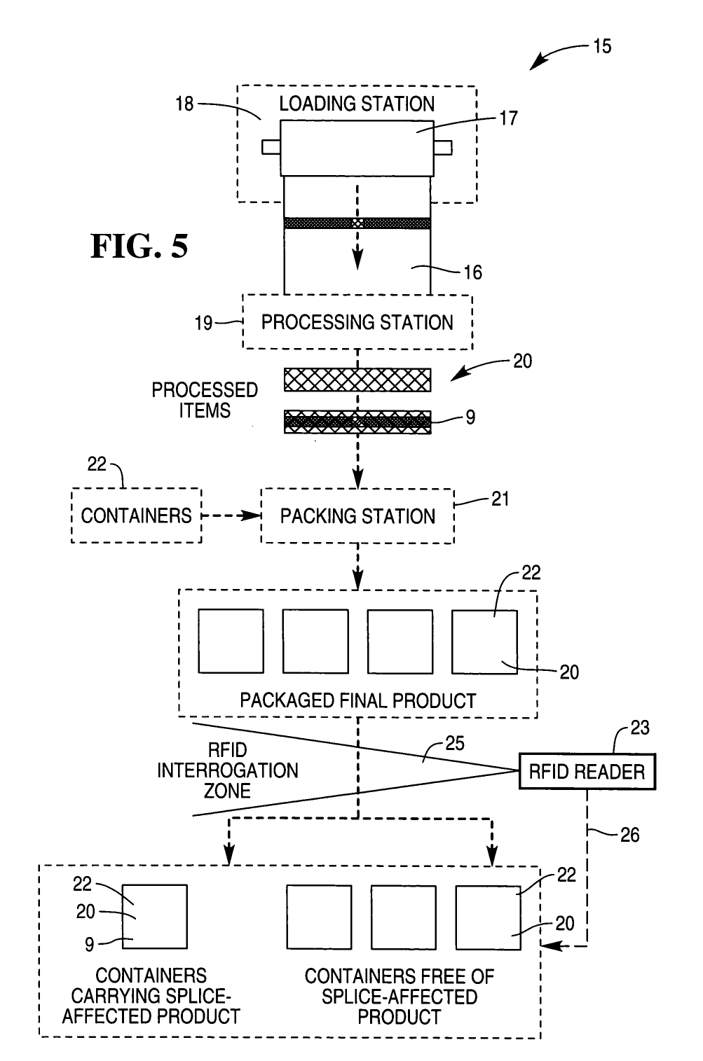

In some cases it is advantageous to conduct detection downstream of packaging, as shown in FIG. 5. In this case, containers 22 are passed through an interrogation zone 25 once they have been filled. In some cases this zone 25 is provided by a handheld RFID scanner. A predetermined quality threshold is typically set to determine whether a container 22 carries greater than an acceptable number of splices. In some cases even one splice is unacceptable, and the threshold number is zero. In other cases a small number of splices is acceptable. For example: a number proportionally small in relation to the total number of items 20. In cases where a container 22 carries greater than the threshold number of splices, that container is set aside. In some cases the unaffected items 20 carried by such a container are re-packaged. However, it often preferred for that container to be sold at a discount rate. In some cases the discount rate is calculated on the basis of the number of detected splices in a given container 22.

It will be appreciated that the effectiveness of reader 23 and tag 6 will have a direct effect on the efficiency and viability of embodiments along the lines of FIG. 5. For example: the read range of tags 6 affect whether reading of packaged tags is feasible. Further, given that a plurality of splices 9 are likely to be simultaneously disposed within zone 25, some steps are taken to ensure that each splice 9 includes only a single tag and that reader 23 is enabled to count the number of tags 6. In some cases tags 6 provide unique packets 8 to assist in this.

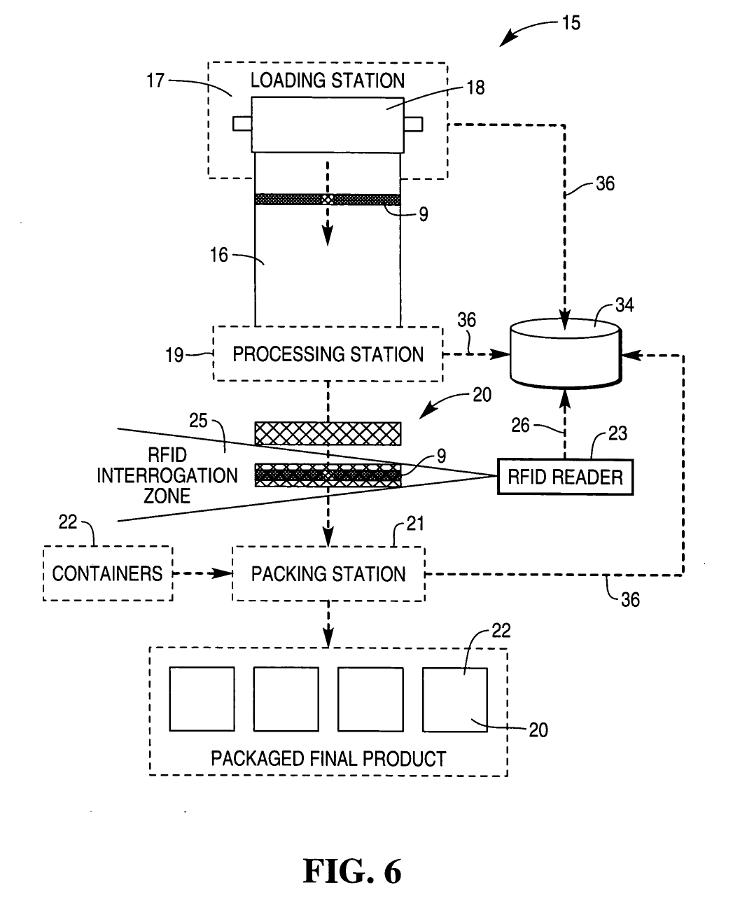

Often, there is no need for physical extraction of a splice-affected portion of paper 16 or a splice affected item 20. In some cases signal 26 used for accounting purposes only. An example is provided by the embodiment of FIG. 6. In this embodiment detection is carried out downstream of processing. Upon detection of splice 9, signal 26 is provided to a database 34. This database maintains a record of the number of splices 9 detected, and typically the times at which they were detected. Database 20 also receives information 36 from stations 18, 19 and 21 to allow for further analysis. For example: to determine the presence and quantity of splices 9 in a specific container 22, or to ascertain the number of splices detected for a given spool 18. Where all data collected in database 34 is time-stamped using time-synchronized equipment, it is possible to correlate information relatively efficiently, and perform post-facto tracking of splices. For example: identification of the spool 18 that provided the splice 19, and the container 22 into which the splice 9 was packaged. In some cases this analysis is used to identify filled containers 22 carrying greater than a threshold number of splices 9. In other cases the analysis is used to maintain accurate supply and billing records on the basis of the number of unaffected items 20 produced and (where relevant) sold.

In some cases, items 20 affected by splices 9 are provided to purchasing parties, however adjustments are made to account for this such that the purchasing party is not unreasonably affected. For example: a purchasing party is billed only for the quantity of unaffected items 20 supplied. Often, the cost of extracting splice-affected goods 20 outweighs the cost of replacement or compensation. This is particularly relevant in high throughput systems.

It will be appreciated that detailed matters of implementation are generally selected on the basis of commercial determinations. Some such determinations are briefly mentioned within the present disclosure, however it will be appreciated that this is for the sake of example only. Practical factors considered when making relevant commercial determinations generally fall outside of the scope of this disclosure. However, those skilled in the relevant art will understand how commercial factors affect the precise manner in which systems such as system 15 are designed and implemented.

In another embodiment purchasers of goods 20 carry out splice detection following delivery of containers 22. For example, portable RFID readers are used to examine containers 22 or items 20 upon delivery.

It will be appreciated that the described embodiments of system 15 do not require specific use of tape 1. That is, embodiments of the present invention are directed toward systems for detection of splices 9 irrespective of whether RFID enabled tape 1 is used. For example, in some cases known splicing tape is used, and an RFID tag is affixed within a predefined proximity of the tape. That is, an RFID tag is affixed to paper 16 adjacent a splice 9.

FIG. 7 illustrates an embodiment where RFID tags 37 and 38 are used in conjunction with a known form of splicing tape 39. In this case, tags 37 and 38 are used to identify a spool-affected portion for extraction by a processing system similar to that shown in FIG. 3. In particular, the packet 8 of tag 37 is indicative of a target cut zone 40. In some cases this is indicated by coordinates, in other cases by relative distances, and, where preferred, by reference to a time code calculated by reference to the rate of movement of paper 16 in system 15. In any event, signal 26 instructs station 19 that a cut is to be made through paper 16 at zone 40. Similarly, the packet 8 of tag 38 results in a signal 26 instructing station 19 to cut at target cutting zone 41.

In some embodiments a packet 8 of a tag 37 or 38 is indicative of “trailing” or “leading” and a length, whilst in other cases the packet simply identifies the tag as being a “leading tag” or “trailing tag” and action is taken on that basis in line with a predetermined protocol. In either case, tags 37 and 38 are used in conjunction with appropriate processing systems to allow for the automated extraction of splice-affected waste portion 30.

A similar result is achievable using tape 1, as shown in FIG. 8. More particularity, tag 6 of tape 1 provides a packet 8 indicative of a leading length 42 and trailing length 43. These lengths allow identification of zones 40 and 41 and hence define the size of splice-affected waste portion 30 to allow for automated extraction of that portion by a suitably configured station 19. In one implementation, variations of tape 1 are manufactured and sold having tags for identifying various waste portion sizes, and a consumer selects an appropriate tape on the basis of the size of a waste splice portion 30 that should be extracted for a given application.

It will be appreciated that other information is stored on tag 6 in further embodiments, primarily dependant on the type and purpose of information that is sought to be obtained. For example, in some cases tag 6 is programmable at the time of splicing to include information indicative of a splicing date and time, an operator, a batch identifier, and any special instructions for splice management. This information is later extracted for purposes such as tracking.

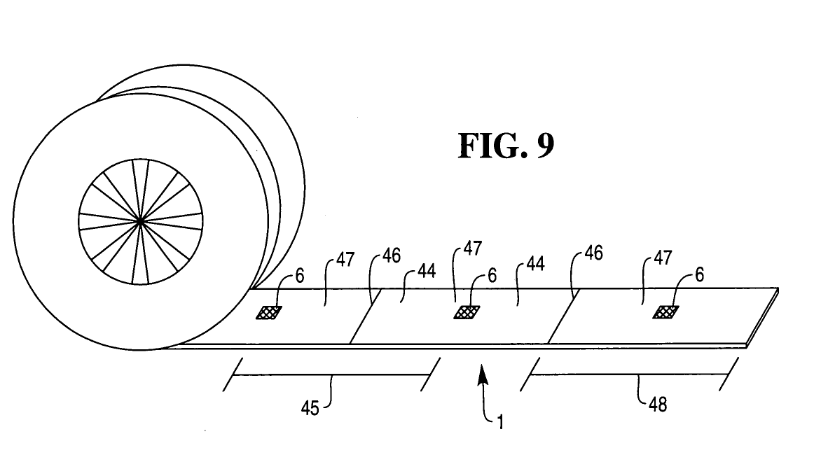

In the embodiment of FIG. 9, tape 1 includes a longitudinally spaced plurality of tags 6, spaced by a predefined spacing dimension 45. Longitudinally spaced markers 46 are provided to designate individual tape portions 47, each portion including a single tag 6. As such, each portion is of a longitudinal dimension 48 substantially equal to dimension 45. In some embodiments these markers are perforated or otherwise adapted to facilitate convenient separation of portions.

In some embodiments several tags 6 are provided on each portion 47 to increase the chances of splice detection. Additionally, although FIG. 9 shows a centrally disposed tag 6, some exemplary alternate locations are indicated by reference numeral 44. A preferred location for tag 6 is often affected by the configuration of reader 23 within system 15. For example, where a conveyor belt is used and reader 23 provided alongside the conveyor belt, it is perhaps more preferable to have a tag 6 closer to marker 46. In situations where the reader is located vertically above the conveyor belt, a central tag 6 is typically suitable. Of course, the read range of tags 6 and the strength of reader 23 play a role in determining what is and is not suitable.

Ideally, tape 1 is manufactured in a variety of size configurations, and a configuration for a given application is selected on the basis of the lateral dimension 49 of the ends 2 and 4 of the material to be spliced. The underlying rationale is to effectively splice the ends using a single portion 47 of tape 1, and as such provide only a single tag 6 on that splice. Typically, it is preferable for dimension 45 to be between approximately 80% and 100% of the dimension 49.

In some embodiments, it is not necessary to ensure that only a single tag 6 or known number of tags 6 is provided for each splice 9. For example, tape 1 includes a closely longitudinally spaced plurality of tags 6 such that more than one tag is likely to be identifiable on a given splice 9. In such cases reader 23 is preferably enabled to recognize that these tags identify a common splice. For example: a signal 26 is only provided for a packet 8 if there has been a threshold time gap since a previous packet 8 was received. It will be appreciated that this time gap is able to be quite slight, given that where a number of tags 6 substantially simultaneously enter zone 25, reader 23 receives the respective packets 8 substantially simultaneously.

Referring to FIG. 9, tape 1 is typically manufactured, sold and managed as a roll 50. In some cases each tag 6 on a roll 50 provides an identical packet 8. However, in other cases the tags provide differing packets 8. For example, the tags provide packets indicative of respective alphanumeric identifiers, these identifiers sequentially increasing or decreasing along the length of the tape. Those skilled in the art will recognize how such approaches are used to facilitate tag uniqueness. For example: each identifier includes portions indicative of a production facility at which the roll was produced, a production time at which the roll's production completed, as well as a sequential identifier that varies among the tags on the roll.

In some cases directionally biased tags 6 are used. For example, tags having an antenna configured to provide a maximum gain in a certain direction defined by reference to the axis of tape 1.

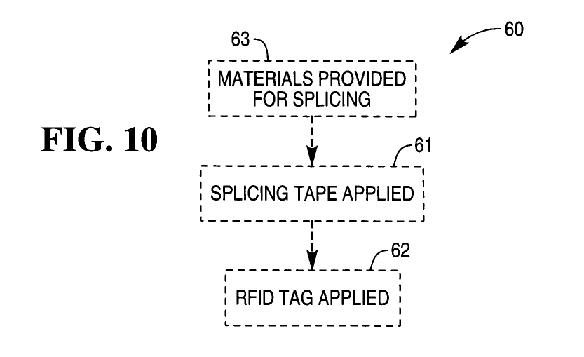

FIG. 10 illustrates an automated splicing system 60. System 60 includes two primary stations: a splicing station 61 and a tagging station 62. In the illustrated embodiment, materials 3 and 5 are provided to station 61 at 63. A known splicing tape is applied to splice end 2 to end 4. Subsequently, a tag 6 is applied to a location fixed with respect to ends 2 and 4. This location need not be on tape 1, and is often substantially adjacent tape 1 on material 3 or 5. It will be appreciated that the formed splice 9 is therefore detectable through a system such as system 15.

The illustrated system 60 is provided as an example only. In other embodiments tag 6 is applied prior to material 3 or 5 prior to splicing. That is, in a production line station 62 precedes station 61. In a further embodiment station 62 applies tag 6 to tape 1 prior to or following splicing. The underlying rationale is that known automatic splicing equipment is used in conjunction with apparatus performing the functionality of station 62. That is, apparatus for applying a tag 6 in a location that is, at least following the splicing process, fixed with respect to splice 9 to allow detection of splice 9.

It will be appreciated that the above disclosure provides tape, processing systems, and splicing techniques that allow for automatic remote detection of splices. Advantageously, this typically allows for more effective processing of spooled raw materials and the like. For example: the presence of a splice is less likely to require slowing of processing equipment or human intervention. Additionally, splice-related data is readily collected and typically used to further improve processing efficiency.

Although the present invention has been described with particular reference to certain preferred embodiments thereof, variations and modifications of the present invention can be effected within the spirit and scope of the following claims.

What is claimed is:

1. Splicing tape for splicing a trailing end of a first material to a leading end of a second material, the splicing tape comprising an identification device responsive to an interrogation signal for providing an information packet.

2. Splicing tape according to claim 1 wherein the identification device is an RFID tag.

3. Splicing tape according to claim 1 further comprising a longitudinally spaced plurality of the identification devices.

4. Splicing tape according to claim 3 wherein the identification devices are equally longitudinally spaced by a predefined spacing dimension.

5. Splicing tape according to claim 4 wherein the first material has a substantially constant lateral dimension, and the spacing dimension is predefined by reference to the lateral dimension.

6. Splicing tape according to claim 5 wherein the spacing dimension is between approximately 80% and 100% of the lateral dimension.

7. Splicing tape according to claim 3 wherein the tape further comprises a plurality of longitudinally spaced markers for designating tape portions, each tape portion including an equal predetermined number of identification devices.

8. Splicing tape according to claim 7 wherein the equal predetermined number is one.

9. Splicing tape according to claim 3 wherein each of the identification devices is indicative of a unique identifier.

10. A system for processing an elongate material having an identification device indicative of a splice, the system comprising:
a station for providing a processing path having an input for receiving the material and an output for dispensing the material;
a reader for providing an interrogation signal intermediate the input and the output to obtain from the identification device an information packet; and
a processor responsive to the information packet for selectively providing a signal.

11. A system according to claim 10 wherein the signal is indicative of positional information relating to the splice.

12. A system according to claim 11 wherein the positional information is indicative of a destination of the splice.

13. A system according to claim 11 wherein the output dispenses the material to a batch, and the positional information is provided to indicate the expected presence of the splice in the batch.

14. A system according to claim 11 wherein the positional information is indicative of the passage of the splice in station.

15. A system according to claim 14 wherein the station further comprises a splice extraction assembly responsive to the positional information for extracting a portion of the material including the splice.

16. A system according to claim 10 wherein the identification device is an RFID tag.

17. A method for identifying a splice in an elongate material, the method comprising the step of mounting an identification device to the material such that the identification device is responsive to an interrogation signal for providing an information packet indicative of the splice.

18. A splicing system including:
a splicing station for splicing a trailing end of a first material to a leading end of a second material; and
a tagging station for mounting an identification device in a position fixed with respect to either or both of the first and second ends.

19. A system according to claim 18 wherein the identification device is responsive to an interrogation signal for providing an information packet.
